(19) United States
(12) Patent Application Publication
(10) Pub. No.: US 2016/0255830 A1
(43) Pub. Date: Sep. 8, 2016

(54) COMPOSITION COMPRISING A PESTICIDE AND AMIDE

(71) Applicant: BASF SE, Ludwigshafen (DE)

(72) Inventors: Kristin Tiefensee, Bad Dürkheim (DE); Ingo Fleute-Schlachter, Essen (DE); Alexander Künkel, Mannheim (DE); Gabriele Steffen, Beltheim (DE)

(21) Appl. No.: 15/031,656

(22) PCT Filed: Oct. 30, 2014
(86) PCT No.: PCT/EP2014/073368

§ 371 Date: Apr. 22, 2016

(30) Foreign Application Priority Data
Nov. 5, 2013 (EP) 13191608.2

(51) Int. Cl. A01N 25/02

(52) U.S. Cl. CPC A01N 25/02

(57) ABSTRACT

The present invention relates to an aqueous composition of a pesticide and a certain carboxylic acid amide. The invention further relates to a method for controlling phytopathogenic fungi and/or undesirable plant growth and/or undesirable insect or mite infestation and/or for regulating the growth of plants, wherein the composition is allowed to act on the respective pests, the habitat thereof or the plants to be protected from the respective pest, on the soil and/or on undesirable plants and/or the crop plants and/or the habitat thereof. Furthermore, the invention relates to the use of the carboxylic acid amide as solvent for pesticides with no or low phytotoxicity.

The present invention relates to an aqueous composition comprising a pesticide and a certain carboxylic acid amide. The invention further relates to a method for controlling phytopathogenic fungi and/or undesirable plant growth and/or undesirable insect or mite infestation and/or for regulating the growth of plants, wherein the composition is allowed to act on the respective pests, the habitat thereof or the plants to be protected from the respective pest, on the soil and/or on undesirable plants and/or the crop plants and/or the habitat thereof. Furthermore, the invention relates to the use of the carboxylic acid amide as solvent for pesticides with no or low phytotoxicity.

The present invention comprises combinations of preferred features with other preferred features.

A large number of liquid concentrates are available to the agricultural markets, and each type of product has its advantages and disadvantages. For example, agrochemical pesticides have the advantages of containing a high concentration of active ingredients, and the ability to incorporate various ingredients into the composition to increase the efficacy of the composition. However, many agrochemicals, in particular pesticide technical grades, have a disadvantage in that they must be dissolved before use, which can be hazardous because of low flash points, environmental toxicity of the solvents, and require substantial mixing and long dissolving times.

There exists in the pesticide industry a great desire to find alternatives to currently used solvents such as isophorone, MBK, NMP, etc. which may be expensive, difficult to source and/or are environmentally unattractive due to their inherent phytotoxicity, toxicity e.g. teratogenicity or regulatory status.

Field tests have shown that certain environmentally favorable solvents may show a negative crop response with excess phytotoxicity.

Hence, there is a need in the agricultural industry for solvents that are capable of maintaining a wide variety of pesticides in solution and that have a reduced toxic response both to the environment and to the crop that is sprayed.

Amides and their use in agrochemical formulations as solvents for inhibiting crystal formation are generally known:

EP 0 044 955 described the use of amides as solvent for liquid herbicide compositions comprising a pyridazone-derivative and a bis-carbamate.

DE 43 41 986 describes the use of amides for the inhibition of crystal formation of agricultural compositions comprising azole-derivatives.

WO 2008/101629 describes biocide compositions comprising at least one dialkylamide based on oleic or linoleic acid, and at least one biocide wherein said dialkylamides reduce the tendency to form crystals.

WO 2010/009829 describes that agricultural compositions comprising biocides and C₈-C₁₂ fatty acid dialkyl amides wherein said C₈-C₁₂ fatty acid dialkyl amides are said to be excellent solvents for a wide range of different herbicides, insecticides and fungicides.

The amides disclosed in the prior art are said to have good solvent properties and that they are capable of inhibiting crystal formation. However, the present inventors have found that certain carboxylic acid amides known in the art have a phytotoxic effect on the plants.

It was therefore an object of the present invention to identify a carboxylic acid amide which is well suited to solve pesticides while being less phytotoxic to plants. Furthermore, the carboxylic acid amide should make possible a storage-stable formulation of the pesticides.

The object was solved by an aqueous composition comprising a pesticide and a carboxylic acid amide according to formula (A)

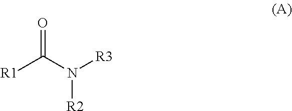

where
R1 is C₂-C₈ alkyl, and
R2 and R3, independently of one another, are C₁-C₆ alkyl, under the proviso that R2 is not C₁-alkyl when R3 is C₁-alkyl,
under the proviso that, if R2 and R3 are C₄-alkyl and R1 is C₂-alkyl or if R2 and R3 are C₂-alkyl and R1 is C₃-alkyl or if R2 and R3 are C₃-alkyl and R1 is C₃-alkyl, the pesticide is not chloridazon, brompyrazon or carbamate, and
under the proviso that, if R2 and R3 are C₂-alkyl and R1 is C₇-C₈-alkyl or if R2 and R3 are C₃-alkyl and R1 is C₃-C₅-alkyl or C₇-C₈-alkyl or if R2 and R3 are C₄-alkyl and R1 is C₂-C₅-alkyl or C₇-C₈-alkyl, the pesticide is not an azole-derivative according to formula (B)

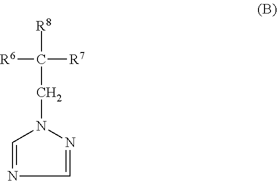

wherein
R⁶ is

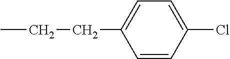

R⁷ is tert.-butyl and R⁸ is hydroxyl, or
R⁶ is 4-fluorphenyl, R⁷ is 2-fluorphenyl and R⁸ is hydroxyl, or
R⁶ is 2,4-dichlorphenyl, R⁷ is n-butyl and R⁸ is hydroxyl, or
R6 is

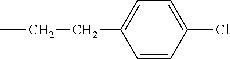

R⁷ is phenyl and R⁸ is cyano, or
R⁶ is 2-chlor-benzyl, R⁷ is 1-chlor-cycloprop-1-yl and R⁸ is hydroxyl, or
R⁶ is 4-chlorphenyl
R7 is

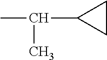

and R⁸ is hydroxyl;
and/or an azole-derivative according to formula (C)

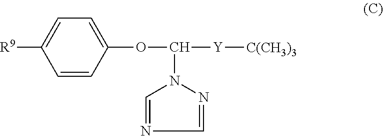

wherein
Y is —CH(OH) and R⁹ is chlor or phenyl, or
Y is CO and R⁹ is chlor
and/or an azole-derivative according to formula (D)

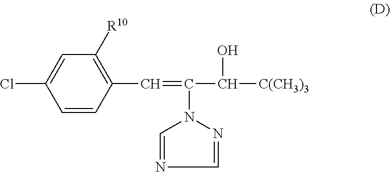

wherein R¹⁰ is hydrogen or chlor,
and/or 1-([bis-(4-fluorphenyl)-methyl-silyl]-methyl)-1H-(1,2,4-triazol) according to formula (E)

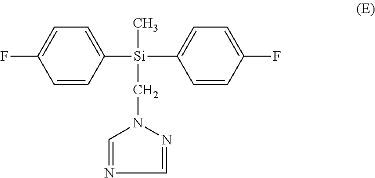 [SMILES: C[Si](Cn1cncn1)(c1ccc(F)cc1)c1ccc(F)cc1]

and/or 1-[3-(2-chlorphenyl)-2-(4-fluorphenyl)-oxiran-2-yl-methyl]-1H-(1,2,4-triazol according to formula (F)

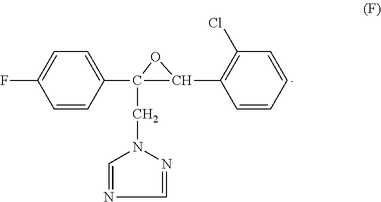 [SMILES: Fc1ccc(C2(Cn3cncn3)OC2c2ccccc2Cl)cc1]

The present inventors have surprisingly found that certain amides have no or only a minimal phytotoxic effect on plants while maintaining their property of solving a wide range of pesticides.

In a preferred embodiment, R2 and R3 are C₂-C₄ alkyl and R1 is C₂-C₈ alkyl. More preferably, R2 and R3 are C₂-C₄ alkyl and R1 is C₂-C₇ alkyl. In an even more preferred embodiment, R2 and R3 are C₂-C₄-alkyl and R1 is C₂-alkyl, in particular R2 and R3 are C₄-alkyl and R1 is C₂-alkyl. In a further preferred embodiment, R2 and R3 are C₄-alkyl and R1 is C₇-alkyl.

The term “alkyl” as used herein denotes in each case a straight-chain or branched alkyl group. In the context of the present invention, “straight-chain alkyl” shall also mean linear alkyl. Examples of an alkyl group are methyl, ethyl, n-propyl, iso-propyl, n-butyl, 2-butyl, iso-butyl, tert-butyl, n-pentyl, 1-methylbutyl, 2-methylbutyl, 3-methylbutyl, 2,2-di-methylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2- trimethylpropyl, 1,2,2-trimethylpropyl, 1-ethyl-1-methylpropyl, and 1-ethyl-2-methylpropyl, etc.

In another preferred embodiment, the present invention pertains to an aqueous composition comprising a pesticide and a carboxylic acid amide according to formula (A)

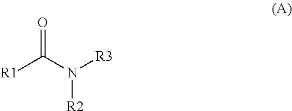

wherein R2 and R3 are straight-chain C₄-alkyl and R1 is straight-chain C₇-alkyl. Such a carboxylic acid amides are also known as N,N-Di-n-butyl-n-Octanamid or N,N-Di-n-butyl caprylamide.

The term pesticide refers to at least one active substance selected from the group of the fungicides, insecticides, nematicides, herbicides, safeners, molluscicides, rodenticides and/or growth regulators. Preferred pesticides are fungicides, insecticides, herbicides and growth regulators. Especially preferred pesticides are herbicides, fungicides and insecticides. Mixtures of pesticides from two or more of the abovementioned classes may also be used. The skilled person is familiar with such pesticides, which can be found, for example, in Pesticide Manual, 14th Ed. (2006), The British Crop Protection Council, London. The above disclosed pesticides can be combined with any carboxylic acid amide of the present invention. Suitable pesticides that can be combined with the carboxylic acid amides of the present invention are:

A) strobilurins:
azoxystrobin, dimoxystrobin, coumoxystrobin, coumethoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, methyl 2-[2-(2,5-dimethylphenyloxymethyl)phenyl]-3-methoxyacrylate, 2-(2-(3-(2,6-di-chlorophenyl)-1-methylallylideneaminooxymethyl)phenyl)-2-methoxyimino-N-methylacetamide;

B) carboxamides:
carboxanilides: benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M (mefenoxam), ofurace, oxadixyl, oxycarboxin, penflufen (N-(2-(1,3-dimethylbutyl)phenyl)-1,3-dimethyl-5-fluoro-1H-pyrazole-4-carboxamide), penthiopyrad, sedaxane, tecloftalam, thifluzamide, tiadinil, 2-amino-4-methylthiazole-5-carboxanilide, N-(3′,4′,5′-trifluorobiphenyl-2-yl)-3-difluoromethyl-1-methyl-1H-pyrazole-4-carboxamide, N-(4′-trifluoromethylthiobiphenyl-2-yl)-3-difluoromethyl-1-methyl-1H-pyrazole-4-carboxamide, N-(2-(1,3,3-trimethylbutyl)-phenyl)-1,3-dimethyl-5-fluoro-1H-pyrazole-4-carboxamide;
carboxylic acid morpholides: dimethomorph, flumorph, pyrimorph;
benzamides: flumetover, fluopicolide, fluopyram, zoxamid;
other carboxamides: carpropamid, diclocymet, mandipropamid, oxytetracyclin, silthiofam, N-(6-methoxypyridin-3-yl)cyclopropanecarboxamide;

C) azoles:
triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole;
imidazoles: cyazofamid, imazalil, imazalil sulfate, pefurazoate, prochloraz, triflumizole;
benzimidazoles: benomyl, carbendazim, fuberidazole, thiabendazole;
others: ethaboxam, etridiazole, hymexazole, 2-(4-chlorophenyl)-N-[4-(3,4-dimethoxyphenyl)isoxazol-5-yl]-2-prop-2-ynyloxyacetamide;

D) nitrogenous heterocyclyl compounds
pyridines: fluazinam, pyrifenox, 3-[5-(4-chlorophenyl)-2,3-dimethylisoxazolidin-3-yl]-pyridine, 3-[5-(4-methylphenyl)-2,3-dimethylisoxazolidin-3-yl]pyridine;
pyrimidines: bupirimate, cyprodinil, diflumetorim, fenarimol, ferimzone, mepanipyrim, nitrapyrin, nuarimol, pyrimethanil;
piperazines: triforine;
pyrroles: fludioxonil, fenpiclonil;
morpholines: aldimorph, dodemorph, dodemorph acetate, fenpropimorph, tridemorph;
piperidines: fenpropidin;
dicarboximides: fluorimid, iprodione, procymidone, vinclozolin;
nonaromatic 5-membered heterocyclic rings: famoxadon, fenamidon, flutianil, octhilinone, probenazole, S-allyl 5-amino-2-isopropyl-3-oxo-4-orthotolyl-2,3-dihydro-pyrazole-1-thiocarboxylate;
others: acibenzolar-S-methyl, amisulbrom, anilazin, blasticidin-S, captafol, captan, quinomethionate, dazomet, debacarb, diclomezine, difenzoquat, difenzoquat methylsulfate, fenoxanil, folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxypyrimidin-2-yl)-2-methyl-1H-benzimidazole, 5-chloro-7-(4-methylpiperidin-1-yl)-6-(2,4,6-trifluorophenyl)-[1,2,4]triazolo[1,5-a]pyrimidine, 5-ethyl-6-octyl-[1,2,4]triazolo[1,5-a]pyrimidin-7-ylamine;

E) carbamates and dithiocarbamates
thio- and dithiocarbamates: ferbam, mancozeb, maneb, metam, methasulphocarb, metiram, propineb, thiram, zineb, ziram;
carbamates: diethofencarb, benthiavalicarb, iprovalicarb, propamocarb, propamocarb hydrochloride, valiphenal, (4-fluorophenyl) N-(1-(1-(4-cyanophenyl)ethanesulfonyl)-but-2-yl)carbamate;

F) other fungicides
guanidines: dodine, dodine free base, guazatine, guazatine acetate, iminoctadine, iminoctadine triacetate, iminoctadine tris(albesilate);
antibiotics: kasugamycin, kasugamycin hydrochloride hydrate, polyoxins, streptomycin, validamycin A;
nitrophenyl derivatives: binapacryl, dicloran, dinobuton, dinocap, nitrothal-isopropyl, tecnazene;
organometallic compounds: fentin salts such as, for example, fentin acetate, fentin chloride, fentin hydroxide;
sulfurous heterocyclyl compounds: dithianon, isoprothiolane;
organophosphorus compounds: edifenphos, fosetyl, fosetyl-aluminum, iprobenfos, phosphorous acid and its salts, pyrazophos, tolclofos-methyl;
organochlorine compounds: chlorthalonil, dichlofluanid, dichlorphen, flusulfamide, hexachlorobenzene, pencycuron, pentachlorophenol and its salts, phthalide, quintozene, thiophanate-methyl, tolylfluanid, N-(4-chloro-2-nitrophenyl)-N-ethyl-4-methylbenzenesulfonamide;
inorganic active substances: phosphorous acid and its salts, Bordeaux mixture, copper salts such as, for example, copper acetate, copper hydroxide, copper oxychloride, basic copper sulfate, sulfur;
biological products for controlling fungi, plant strengthening products: Bacillus subtilis strain NRRL No. B-21661 (for example the products RHAPSODY®, SERENADE® MAX and SERENADE® ASO from AgraQuest, Inc., USA.), Bacillus pumilus strain NRRL No. B-30087 (for example SONATA® and BALLAD® Plus from AgraQuest, Inc., USA), Ulocladium oudemansii (for example BOTRY-ZEN from BotriZen Ltd., New Zealand), chitosan (for example ARMOUR-ZEN from BotriZen Ltd., New Zealand).
others: biphenyl, bronopol, cyflufenamid, cymoxanil, diphenylamine, metrafenon, mildiomycin, oxine-copper, prohexadione-calcium, spiroxamin, tolylfluanid, N-(cyclopropylmethoxyimino-(6-difluoromethoxy-2,3-difluorophenyl)methyl)-2-phenyl-acetamide, N′-(4-(4-chloro-3-trifluoromethylphenoxy)-2,5-dimethylphenyl)-N-ethyl-N-methylformamidine, N′-(4-(4-fluoro-3-trifluoromethylphenoxy)-2,5-dimethylphenyl)-N-ethyl-N-methylformamidine, N′-(2-methyl-5-trifluoromethyl-4-(3-trimethylsilanylpropoxy)phenyl)-N-ethyl-N-methylformamidine, N′-(5-difluoromethyl-2-methyl-4-(3-trimethylsilanylpropoxy)phenyl)-N-ethyl-N-methylformamidine, N-methyl-(1,2,3,4-tetrahydronaphthalen-1-yl)-2-{1-[2-(5-methyl-3-trifluoromethylpyrazol-1-Aacetyl]piperidin-4-yl}thiazole-4-carboxylate, N-methyl-(R)-1,2,3,4-tetrahydronaphthalen-1-yl 2-{1-[2-(5-methyl-3-trifluoromethylpyrazol-1-yl)acetyl]piperidin-4-yl}thiazole-4-carboxylate, 6-tert-butyl-8-fluoro-2,3-dimethylquinolin-4-yl acetate, 6-tert-butyl-8-fluoro-2,3-dimethylquinolin-4-yl methoxyacetate, N-methyl-2-{1-[2-(5-methyl-3-trifluoromethyl-1H-pyrazol-1-yl)acetyl]piperidin-4-yl}-N-[(1R)-1,2,3,4-tetrahydronaphthalen-1-yl]-4-thiazolecarboxamide;

G) growth regulators
abscisic acid, amidochlor, ancymidole, 6-benzylaminopurine, brassinolide, butralin, chlormequat (chlormequat chloride), choline chloride, cyclanilid, daminozide, dikegulac, dimethipin, 2,6-dimethylpuridine, ethephon, flumetralin, flurprimidol, fluthiacet, forchlorfenuron, gibberellic acid, inabenfid, indole-3-acetic acid, maleic hydrazide, mefluidid, mepiquat (mepiquat chloride), metconazole, naphthaleneacetic acid, N-6-benzyladenine, paclobutrazole, prohexadione (prohexadione-calcium), prohydrojasmone, thidiazuron, triapenthenol, tributylphosphorotrithioate, 2,3,5-triiodobenzoic acid, trinexapac-ethyl and uniconazole;

H) herbicides
acetamide: acetochlor, alachlor, butachlor, dimethachlor, dimethenamid, flufenacet, mefenacet, metolachlor, metazachlor, napropamid, naproanilid, pethoxamid, pretilachlor, propachlor, thenylchlor;
amino acid analogs: bilanafos, glyphosate, glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
bipyridyls: diquat, paraquat;
carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bromoxynil, dichlobenil, ioxynil;
imidazolinones: imazamethabenz, imazamox, imazapic, imazapyr, imazaquin, imazethapyr;
phenoxyacetic acids: clomeprop, 2,4-dichlorophenoxyacetic acid (2,4-D), 2,4-DB, dichlorprop, MCPA, MCPA-thioethyl, MCPB, mecoprop;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonylureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propylimidazo[1,2-b]pyridazin-3-yl)sulfonyl)-3-(4,6-dimethoxypyrimidin-2-yl)urea;
triazines: ametryne, atrazine, cyanazine, dimethametryne, ethiozine, hexazinone, metamitron, metribuzine, prometryne, simazine, terbuthylazine, terbutryne, triaziflam;
ureas: chlortoluron, daimuron, diuron, fluometuron, isoproturon, linuron, methabenzthiazuron, tebuthiuron;
other acetolactate synthase inhibitors: bispyribac-sodium, cloransulam-methyl, diclosulam, florasulam, flucarbazone, flumetsulam, metosulam, orthosulfamuron, penoxsulam, propoxycarbazone, pyribambenz-propyl, pyribenzoxim, pyriftalide, pyriminobac-methyl, pyrimisulfan, pyrithiobac, pyroxasulfon, pyroxsulam;
others: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethlyl, chlorthal, cinmethylin, clomazone, cumyluron, cyprosulfamid, dicamba, difenzoquat, diflufenzopyr, Drechslera monoceras, endothal, ethofumesate, etobenzanid, fentrazamide, flumiclorac-pentyl, flumioxazin, flupoxam, fluorochloridon, flurtamon, indanofan, isoxaben, isoxaflutol, lenacil, propanil, propyzamide, quinclorac, quinmerac, mesotrione, methylarsenic acid, naptalam, oxadiargyl, oxadiazone, oxaziclomefon, pentoxazone, pinoxaden, pyraclonil, pyraflufen-ethyl, pyrasulfotol, pyrazoxyfen, pyrazolynate, quinoclamin, saflufenacil, sulcotrione, sulfentrazone, terbacil, tefuryltrione, tembotrione, thiencarbazone, topramezone, 4-hydroxy-3-[2-(2-methoxyethoxymethyl)-6-trifluoromethylpyridin-3-carbonyl]bicyclo[3.2.1]oct-3-en-2-one,
ethyl (3-[2-chloro-4-fluoro-5-(3-methyl-2,6-dioxo-4-trifluoromethyl-3,6-dihydro-2H-pyrimidin-1-yl)phenoxy]pyridin-2-yloxy)acetate, methyl 6-amino-5-chloro-2-cyclo-propylpyrimidine-4-carboxylate, 6-chloro-3-(2-cyclopropyl-6-methylphenoxy)-pyridazin-4-ol, 4-amino-3-chloro-6-(4-chlorophenyl)-5-fluoropyridin-2-carboxylic acid, methyl 4-amino-3-chloro-6-(4-chloro-2-fluoro-3-methoxyphenyl)pyridin-2-carboxylate and methyl 4-amino-3-chloro-6-(4-chloro-3-dimethylamino-2-fluorophenyl)pyridin-2-carboxylate;

I) insecticides
organo(thio)phosphates: acephate, azamethiphos, azinphos-methyl, chlorpyrifos, chlorpyrifos-methyl, chlorfenvinphos, diazinon, dichlorvos, dicrotophos, dimethoat, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, taufluvalinate, tefluthrin, tetramethrin, tralomethrin, transfluthrin, profluthrin, dimefluthrin,
insect growth inhibitors: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazin; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramate;
nicotine receptor agonists/antagonists: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl-[1,3,5]triazinane;
GABA antagonists: endosulfan, ethiprole, fipronil, vaniliprole, pyrafluprole, pyriprole, N-5-amino-1-(2,6-dichloro-4-methylphenyl)-4-sulfinamoyl-1H-pyrazole-3-thiocarboxamide;
macrocyclic lactones: abamectin, emamectin, milbemectin, lepimectin, spinosad, spinetoram;
mitochondrial electron transport chain inhibitor (METI) I acaricides: fenazaquin, pyridaben, tebufenpyrad, tolfenpyrad, flufenerim;
METI II and III substances: acequinocyl, fluacyprim, hydramethylnone;
decouplers: chlorfenapyr;
inhibitors of oxidative phosphorylation: cyhexatin, diafenthiuron, fenbutatin oxide, propargite;
insect ecdysis inhibitors: cryomazin;
‘mixed function oxidase’ inhibitors: piperonyl butoxide;
sodium channel blockers: indoxacarb, metaflumizon;
others: benclothiaz, bifenazate, cartap, flonicamid, pyridalyl, pymetrozin, sulfur, thiocyclam, flubendiamid, chlorantraniliprole, cyazypyr (HGW86); cyenopyrafen, flupyrazofos, cyflumetofen, amidoflumet, imicyafos, bistrifluron and pyrifluquinazone.

In a preferred embodiment, the composition comprises a carboxylic acid amide as defined above and a pesticide selected from the group consisting of anilide, nitrophenylether, pyridine, triazole, methoxycarbamate, strobilurine, pyrazole. In a further preferred embodiment, the composition comprises a carboxylic acid amide as defined above and a pesticide selected from the group consisting of tebuconazole, pyraclostrobin and fluxapyroxad.

In another preferred embodiment, the present invention pertains to an aqueous composition comprising a pesticide and a carboxylic acid amide according to formula (A)

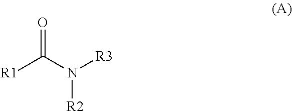

wherein R2 and R3 are straight-chain C₄-alkyl and R1 is straight-chain C₇-alkyl and wherein the pesticide is selected from fungicides, herbicides and insecticides, preferably from the group consisting of anilide, nitrophenylether, pyridine, triazole, methoxycarbamate, strobilurine and pyrazole, even more preferably from the group consisting of tebuconazole, pyraclostrobin and fluxapyroxad.

The compositions according to the invention can furthermore also comprise adjuvants conventionally used for agrochemical formulations, the choice of the adjuvants depending on the specific use form, the type of formulation or the active substance. Examples of suitable adjuvants are solvents, solid carriers, surface-active substances (such as surfactants, solubilizers, protective colloids, wetters and tackifiers), organic and inorganic thickeners, bactericides, antifreeze agents, antifoams, optionally colorants and adhesives (for example for the treatment of seed) or conventional adjuvants for bait formulations (for example attractants, feedants, bittering substances).

The compositions according to the present invention can also comprise further oil components and/or co-solvents other than carboxylic acid amides as defined above. Suitable oil components and co-solvents are water or organic solvents such as mineral oil fractions of medium to high boiling point such as kerosene and diesel oil, furthermore coal tar oils and oils of vegetable or animal origin, aliphatic, cyclic and aromatic hydrocarbons, for example paraffins, tetrahydronaphthalene, alkylated naphthalenes and their derivatives, alkylated benzenes and their derivatives, alcohols such as methanol, ethanol, propanol, butanol and cyclohexanol, glycols, ketones such as cyclohexanone, gamma-butyrolactone, fatty acids and fatty acid esters, and strongly polar solvents, for example amines such as N-methylpyrrolidone. In principle, it is also possible to use solvent mixtures and mixtures of the abovementioned solvents and water.

The compositions of the present invention can also comprise solid carriers. Solid carriers are mineral earths such as silicas, silica gels, silicates, talc, kaolin, limestone, lime, chalk, bole, loess, clay, dolomite, diatomaceous earth, calcium and magnesium sulfate, magnesium oxide, ground synthetic materials, fertilizers such as ammonium sulfate, ammonium phosphate, ammonium nitrate, ureas and vegetable products such as cereal meal, tree bark meal, wood meal and nutshell meal, cellulose powders or other solid carriers.

The compositions of the present invention can additionally comprise surface-active substances. Surface-active substances (adjuvants, wetters, tackifiers, dispersants or emulsifiers) which are suitable to be used in combination with the compositions of the present invention are the alkali metal, alkaline-earth metal, ammonium salts of aromatic sulfonic acids, for example of lignosulfonic acid (Borresperse® types, Borregaard, Norway), phenolsulfonic acid, naphthalenesulfonic acid (Morwet® types, Akzo Nobel, USA) and dibutylnaphthalenesulfonic acid (Nekal® types, BASF, Germany), and of fatty acids, alkyl- and alkylarylsulfonates, alkyl ether, lauryl ether and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ethers, tributylphenyl polyglycol ether, alkylaryl polyether alcohols, isotridecyl alcohol, fatty alcohol/ethylene oxide condensates, ethoxylated castor oil, polyoxyethylene or polyoxypropylene alkyl ethers, lauryl alcohol polyglycol ether acetate, sorbitol esters, lignin-sulfite liquors and proteins, denatured proteins, polysaccharides (for example methylcellulose), hydrophobe-modified starches, polyvinyl alcohol (Mowiol® types, Clariant, Switzerland), polycarboxylates (Sokalan® types, BASF, Germany), polyalkoxylates, polyvinylamine (Lupamin® types, BASF, Germany), polyethyleneimine (Lupasol® types, BASF, Germany), polyvinyl-pyrrolidone and their copolymers.

The composition according to the invention may comprise from 0.1 to 40% by weight, preferably from 1 to 30 and in particular from 2 to 20% by weight of surface-active substances (as disclosed above), the amount of the carboxylic acid amide not being taken into consideration.

Suitable thickeners that can be used in a composition of the present invention are compounds which impart to the formulation a modified flow behavior, i.e. high viscosity at rest and low viscosity in the agitated state. Examples are polysaccharides, proteins (such as casein or gelatins), synthetic polymers, or inorganic layered minerals. Such thickeners are commercially available, for example Xanthan Gum (Kelzan®, CP Kelco, USA), Rhodopol® 23 (Rhodia, France) or Veegum® (R.T. Vanderbilt, USA) or Attaclay® (Engelhard Corp., NJ, USA). The thickener content in the formulation depends on the efficacy of the thickener. The skilled person will choose an amount suitable to obtain the desired viscosity of the formulation. The content will amount to from 0.01 to 10% by weight in most cases.

Bactericides may be added in order to stabilize the composition of the present invention. Examples of bactericides are those based on diclorophene and benzyl alcohol hemiformal and also isothiazolinone derivatives such as alkylisothiazolinones and benzoisothiazolinones (Acticide® MBS from Thor Chemie). Examples of suitable antifreeze agents are ethylene glycol, propylene glycol, urea and glycerol. Examples of antifoams are silicone emulsions (such as, for example, Silikon® SRE, Wacker, Germany or Rhodorsil®, Rhodia, France), long-chain alcohols, fatty acids, salts of fatty acids, organofluorine compounds and mixtures of these.

The composition according to the invention can preferably be present in the form of an agrochemical formulation. Examples of such formulations and their preparation are:
i) Water-soluble concentrates (SL, LS): 10 parts by weight of the active substances are dissolved using 90 parts by weight of water or a water-soluble solvent. Alternatively, wetters or other adjuvants are added. Upon dilution in water, the active substance dissolves. This gives a composition with an active substance content of 10% by weight.
ii) Dispersible concentrates (DC): 20 parts by weight of the active substances are dissolved in 70 parts by weight of NMP with addition of 10 parts by weight of a dispersant, for example polyvinylpyrrolidone. Upon dilution in water, a dispersion is obtained. The active substance content amounts to 20% by weight.
iii) Emulsifiable concentrates (EC): 15 parts by weight of the active substances are dissolved in 75 parts by weight of solvent naphta with addition of calcium dodecylbenzenesulfonate and castor oil ethoxylate (in each case 5 parts by weight). Upon dilution in water, an emulsion is obtained. The composition has an active substance content of 15% by weight.
iv) Emulsions (EW, EO, ES): 25 parts by weight of the active substances are dissolved in 35 parts by weight of xylene with addition of calcium dodecylbenzene-sulfonate and castor oil ethoxylate (in each case 5 parts by weight). Using an emulsifier (for example Ultra-Turrax), this mixture is placed into 30 parts by weight of water and made into a homogeneous emulsion. Upon dilution in water, an emulsion is obtained. The composition has an active substance content of 25% by weight.
v) Suspensions (SC, OD, FS): 20 parts by weight of the active substances are comminuted with addition of 10 parts by weight of dispersants and wetters and 70 parts by weight of water or an organic solvent in a stirred-ball mill to give a finely divided active substance suspension. Upon dilution in water, a stable suspension of the active substance is obtained. The active substance content in the composition amounts to 20% by weight.
vi) Water-dispersible and water-soluble granules (WG, SG): 50 parts by weight of the active substances are ground finely with addition of 50 parts by weight of dispersants and wetters and formulated as water-dispersible or water-soluble granules by means of technical apparatuses (for example extrusion, spray tower, fluidized bed). Upon dilution in water, a stable dispersion or solution of the active substance is obtained. The composition has an active substance content of 50% by weight.
vii) Water-dispersible and water-soluble powders (WP, SP, SS, WS): 75 parts by weight of the active substances are ground in a rotor-stator mill with addition of 25 parts by weight of dispersants and wetters and also silica gel. Upon dilution in water, a stable dispersion or solution of the active substance is obtained. The active substance content of the composition amounts to 75% by weight.
viii) Gels (GF): in a ball mill, 20 parts by weight of the active substances, 10 parts by weight of dispersant, 1 part by weight of gelling agent and 70 parts by weight of water or an organic solvent are ground to give a fine suspension. Upon dilution with water, a stable suspension with an active substance content of 20% by weight is obtained.
ix) Dusts (DP, DS): 5 parts by weight of the active substances are ground finely and mixed intimately with 95 parts by weight of finely divided kaolin. This gives a dust with an active substance content of 5% by weight.
x) Granules (GR, FG, GG, MG): 0.5 part by weight of the active substances is ground finely and associated with 99.5 parts by weight of carriers. Conventional methods to this end are extrusion, spray-drying or the fluidized bed. This gives granules for direct application with an active substance content of 0.5% by weight.
xi) ULV solutions (UL): 10 parts by weight of the active substances are dissolved in 90 parts by weight of an organic solvent, for example xylene. This gives a composition to be applied directly with an active substance content of 10% by weight.

In a preferred embodiment, the compositions of the present invention are emulsifiable concentrates (EC).

In general, the compositions of the present invention comprise from 0.01 to 95% by weight, preferably from 0.1 to 90% by weight, of the pesticides.

In most cases, the composition according to the invention comprises from 0.1 to 90% by weight of the carboxylic acid amide as defined above, preferably from 10 to 80% by weight and in particular from 20 to 70% by weight.

In a preferred embodiment, the composition according to the invention comprises
5 to 60% by weight of pesticide as defined above,
1 to 30% by weight of surface-active substances as defined above,
0 to 50% by weight of oil components and/or co-solvents, and
0.1 to 90% by weight of carboxylic acid amide as defined above,
   on the condition that the amounts add with water to 100% by weight.

The user will generally use the composition according to the invention in a premetering device, in a knapsack sprayer, in a spray tank or in a spraying aircraft. Here, said composition is brought to the desired use concentration with water and/or buffer, optionally with addition of further auxiliaries, whereby the ready-to-use spray mixture (known as a tank mix) is obtained. Usually, 50 to 500 liters of the ready-to-use spray mixture are applied per hectare of utilizable agricultural area, preferably from 100 to 400 liters. In specific segments the amounts may also be above (e.g., fruit growing) or below (e.g., aircraft application) these amounts. The active substance concentrations in the ready-to-use preparations may be varied within substantial ranges. In general, they are between 0.0001 and 10%, preferably between 0.01 and 1%.

Oils of various types, wetters, drift reduction agents, stickers, spreaders, adjuvants, fertilizers, plant-strengthening products, trace elements, herbicides, bactericides, fungicides and/or pesticides may be added to the active substances or to the preparations comprising them, optionally also to the tank mix, immediately prior to use. These products can be admixed to the compositions according to the invention in the weight ratio 1:100 to 100:1, preferably 1:10 to 10:1. Adjuvants which are suitable within this context are in particular: organic-modified polysiloxanes, for example Break Thru S 240®; alcohol alkoxylates, for example Atplus® 245, Atplus® MBA 1303, Plurafac® LF 300 and Lutensol® ON 30; EO/PO block polymers, for example Pluronic® RPE 2035 and Genapol® B; alcohol ethoxylates, for example Lutensol® XP 80; and sodium dioctyl sulfosuccinate, for example Leophen® RA.

Depending on the nature of the desired effect, the application rates of the active substance when used in plant protection are between 0.001 and 2.0 kg of active substance per ha, preferably between 0.005 and 2 kg per ha, especially preferably between 0.05 and 0.9 kg per ha, in particular between 0.1 and 0.75 kg per ha.

The present invention furthermore relates to a method for controlling phytopathogenic fungi and/or undesirable plant growth and/or undesirable insect or mite infestation and/or for regulating the growth of plants, wherein the composition according to the present invention as defined above is allowed to act on the respective pests, the habit thereof or the plants to be protected from the respective pest, on the soil and/or on undesirable plants and/or the crop plants and/or the habitat thereof.

Examples of suitable crop plants are cereals, for example wheat, rye, barley, triticale, oats or rice; beet, for example sugar or fodder beet; pome fruit, stone fruit and soft fruit, for example apples, pears, plums, peaches, almonds, cherries, strawberries, raspberries, currants or gooseberries; legumes, for example beans, lentils, peas, lucerne or soybeans; oil crops, for example oilseed rape, mustard, olives, sunflowers, coconut, cacao, castor beans, oil palm, peanuts or soybeans; cucurbits, for example pumpkins/squash, cucumbers or melons; fiber crops, for example cotton, flax, hemp or jute; citrus fruit, for example oranges, lemons, grapefruit or tangerines; vegetable plants, for example spinach, lettuce, asparagus, cabbages, carrots, onions, tomatoes, potatoes, pumpkin/squash or capsicums; plants of the laurel family, for example avocados, cinnamon or camphor; energy crops and industrial feedstock crops, for example maize, soybeans, wheat, oilseed rape, sugar cane or oil palm; tobacco; nuts; coffee; tea; bananas; wine (dessert grapes and grapes for vinification); hops; grass, for example turf; sweetleaf (Stevia rebaudania); rubber plants and forest plants, for example flowers, shrubs, deciduous trees and coniferous trees, and propagation material, for example seeds, and harvested products of these plants.

The term crop plants also includes those plants which have been modified by breeding, mutagenesis or recombinant methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the plant's properties. Such recombinant modifications also comprise posttranslational modifications of proteins, oligo- or polypeptides, for example by means of glycosylation or binding of polymers such as, for example, prenylated, acetylated or farnesylated residues or PEG residues.

Examples which may be mentioned are plants which, as the result of plant-breeding and recombinant measures, have acquired a tolerance for certain classes of herbicides, such as hydroxyphenylpyruvate dioxygenase (HPPD) inhibitors, acetolactate synthase (ALS) inhibitors such as, for example, sulfonylureas (EP-A 257 993, U.S. Pat. No. 5,013,659) or imidazolinones (for example U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073), enolpyruvylshikimate 3-phosphate synthase (EPSPS) inhibitors such as, for example, glyphosate (see, for example, WO 92/00377), glutamine synthetase (GS) inhibitors such as, for example, glufosinate (see, for example, EP-A 242 236, EP-A 242 246) or oxynil herbicides (see, for example, U.S. Pat. No. 5,559,024). For example, breeding and mutagenesis have given rise to Clearfield® oilseed rape (BASF SE, Germany), which features tolerance for imidazolinones, for example imazamox. With the aid of recombinant methods, crop plants such as soybeans, cotton, maize, beet and oilseed rape have been generated which are resistant to glyphosate or glufosinate, and these are available by the brand names RoundupReady® (glyphosate-resistant, Monsanto, U.S.A.) and Liberty Link® (glufosinate-resistant, Bayer CropScience, Germany). Also comprised are plants which, with the aid of recombinant measures, produce one or more toxins, for example those from the bacterial strain Bacillus. Toxins which are produced by such genetically modified plants comprise, for example, insecticidal proteins of Bacillus spp., in particular from B. thuringiensis, such as the endotoxins Cry1Ab, Cry1Ac, Cry1F, Cry1Fa2, Cry2Ab, Cry3A, Cry3Bb1, Cry9c, Cry34Ab1 or Cry35Ab1; or vegetable insecticidal proteins (VIPs), for example VIP1, VIP2, VIP3, or VIP3A; insecticidal proteins from nematode-colonizing bacteria, for example Photorhabdus spp. or Xenorhabdus spp.; toxins from animal organisms, for example wasp, spider or scorpion toxins; fungal toxins, for example from Streptomycetes; plant lectins, for example from pea or barley; agglutinins; proteinase inhibitors, for example trypsin inhibitors, serine protease inhibitors, patatin, cystatin or papain inhibitors; ribosome-inactivating proteins (RIPs), for example ricin, maize RIP, abrin, luffin, saporin or bryodin; steroid-metabolizing enzymes, for example 3-hydroxysteroid oxidase, ecdysteroid IDP glycosyl transferase, cholesterol oxidase, ecdysone inhibitors or HMG CoA-reductase; ion channel blockers, for example inhibitors of sodium or calcium channels; juvenile hormone esterase; receptors for the diuretic hormone (helicokinin receptors); stilbene synthase, bibenzyl synthase, chitinases and glucanases. These toxins can also be produced, in the plants, in the form of pretoxins, hybrid proteins, truncated or otherwise modified proteins. Hybrid proteins are distinguished by a novel combination of different protein domains (see, for example, WO 2002/015701). Further examples of such toxins or genetically modified plants which produce these toxins are disclosed in EP-A 374 753, WO 93/07278, WO 95/34656, EP-A 427 529, EP-A 451 878, WO 03/18810 and WO 03/52073. The methods for generating these genetically modified plants are known to the skilled person and explained, for example, in the abovementioned publications. A large number of the abovementioned toxins impart to the plants which produce them a tolerance for pests from all taxonomic classes of the arthropods, in particular beetles (Coeleropta), dipterans (Diptera) and lepidopterans (Lepidoptera) and nematodes (Nematoda). Genetically modified plants having one or more genes which code for insecticidal toxins are described for example in the abovementioned publications and are in some cases commercially available such as, for example, YieldGard® (maize varieties which produce the toxin Cry1Ab), YieldGard® Plus (maize varieties which produce the toxins Cry1Ab and Cry3Bb1), Starlink® (maize varieties which produce the toxin Cry9c), Herculex® RW (maize varieties which produce the toxins Cry34Ab1, Cry35Ab1 and the enzyme phosphinothricin N-acetyltransferase [PAT]); NuCOTN® 33B (cotton varieties which produce the toxin Cry1Ac), Bollgard® I (cotton varieties which produce the toxin Cry1Ac), Bollgard® II (cotton varieties which produce the toxins Cry1Ac and Cry2Ab2); VIPCOT® (cotton varieties which produce a VIP toxin); NewLeaf® (potato varieties which produce the toxin Cry3A); Bt-Xtra®, NatureGard®, KnockOut®, BiteGard®, Protecta®, Bt11 (for example Agrisure® CB) and Bt176 from Syngenta Seeds SAS, France, (maize varieties which produce the toxin Cry1Ab and the PAT enzyme), MIR604 from Syngenta Seeds SAS, France (maize varieties which produce a modified version of the toxin Cry3A, see in this context WO 03/018810), MON 863 from Monsanto Europe S.A., Belgium (maize varieties which produce the toxin Cry3Bb1), IPC 531 from Monsanto Europe S.A., Belgium (cotton varieties which produce a modified version of the toxin Cry1Ac) and 1507 from Pioneer Overseas Corporation, Belgium (maize varieties which produce the toxin Cry1F and the PAT enzyme).

Also comprised are plants which, with the aid of recombinant measures, produce one or more proteins which bring about an increased resistance to, or ability to withstand, bacterial, viral or fungal pathogens such as, for example, so-called pathogenesis-related proteins (PR proteins, see EP-A 0 392 225), resistance proteins (for example potato varieties which produce two resistance genes against Phytophthora infestans from the Mexican wild potato Solanum bulbocastanum) or T4 lysozyme (for example potato varieties which, as the result of the production of this protein, are resistant to bacteria such as Erwinia amylvora).

Also comprised are plants whose productivity has been improved with the aid of recombinant methods, for example by increasing the yield potential (for example biomass, grain yield, starch content, oil content or protein content), the tolerance for drought, salt or other limiting environmental factors, or the resistance to pests and fungal, bacterial and viral pathogens.

Also comprised are plants whose constituents, in particular for improving human or animal nutrition, have been modified with the aid of recombinant methods, for example by oil plants producing health-promoting long-chain omega-3-fatty acids or monounsaturated omega-9-fatty acids (for example Nexera® oilseed rape, DOW Agro Sciences, Canada).

The present invention also relates to the use of a carboxylic acid amide according to formula (A)

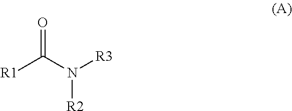

where
R1 is C₂-C₈ alkyl, and
R2 and R3, independently of one another, are C₁-C₆ alkyl, under the proviso that R2 is not C₁-alkyl when R3 is C₁-alkyl, as solvent for pesticides with no or low phytotoxicity. In a preferred embodiment, a carboxylic acid amide where R2 and R3 are C₂-C₄ alkyl and R1 is C₂-C₈ alkyl is used as solvent with no or low phytotoxicity for pesticides. More preferably, a carboxylic acid amide is used where R2 and R3 are C₂-C₄ alkyl and R1 is C₂-C₇ alkyl as solvent with no or low phytotoxicity for pesticides. In an even more preferred embodiment, a carboxylic acid amide where R2 and R3 are C₂-C₄-alkyl and R1 is C₂-alkyl, in particular R2 and R3 are C₄-alkyl and R1 is C₂-alkyl is used as solvent with no or low phytotoxicity for pesticides. In a further preferred embodiment, a carboxylic acid amide where R2 and R3 are C₄-alkyl and R1 is C₇-alkyl is used as solvent with no or low phytotoxicity for pesticides. In a more preferred embodiment, a carboxylic acid amide where R2 and R3 are straight-chain C₄-alkyl and R1 is straight-chain C₇-alkyl is used as solvent with no or low phytotoxicity for pesticides.

In a preferred embodiment, no phytotoxicity means 0% of the treated plants have plant injury as compared to untreated plants when determined with the phytotoxicity method as described in the description below.

In a preferred embodiment, low phytotoxicity means 1 to 10% of the treated plants have plant injury as compared to untreated plants when determined with the phytotoxicity method as described in the description below.

Phytotoxicity in accordance with the present invention is determined by an assay where a spray comprising water (aqua dest.) and carboxylic acid amide (200 l/ha comprising 1500 ml carboxylic acid amide/ha) is prepared and applied on plants of barley (cultivar Lawina) being in 3-4 leaf stage at a water application rate of 1.5 l/ha. The experimental period lasts for 10 days. During this time, the experimental plants receive optimum watering, with nutrients being supplied via the water used for watering.

The phytotoxicity is evaluated by awarding scores to the treated plants in comparison to untreated plants, i.e. treated with water only. The evaluation scale ranges from 0% to 100% phytotoxicity. The evaluation is done by visual examination. 0% phytotoxicity means that there are no differences between treated and untreated plants. Thus, no phytotoxicity in accordance with the present invention means that the treated plants to not have plant injury and there is no difference between treated and untreated plants. Low phytotoxicity in accordance with the present invention means that only 1 to 10% of the treated plants have plant injury as compared to untreated plants.

The present invention also relates to a method for treating plants, thereby maintaining plant health comprising the step of mixing a carboxylic acid amide as defined above, with one or more pesticides described in the present disclosure.

In a preferred embodiment, the method comprises mixing a carboxylic acid amide where R2 and R3 are C₂-C₄ alkyl and R1 is C₂-C₈ alkyl with one or more pesticides. More preferably, the method comprises mixing a carboxylic acid amide where R2 and R3 are C₂-C₄ alkyl and R1 is C₂-C₇ alkyl with one or more pesticides. In an even more preferred embodiment, the method comprises mixing a carboxylic acid amide where R2 and R3 are C₂-C₄-alkyl and R1 is C₂-alkyl, in particular R2 and R3 are C₄-alkyl and R1 is C₂-alkyl with one or more pesticides. In a further preferred embodiment, the method comprises mixing a carboxylic acid amide where R2 and R3 are C₄-alkyl and R1 is C₇-alkyl with one or more pesticides. In a further preferred embodiment, the method comprises mixing a carboxylic acid amide where R2 and R3 are straight-chain C₄-alkyl and R1 is straight-chain C₇-alkyl with one or more pesticides.

Preferable, the carboxylic acid amide as defined above in an amount of from 10% by weight to 90% by weight, preferably from 30% by weight to 80% by weight is mixed with one or more pesticides.

Finally, the present invention further relates to a method for producing the composition of the present invention comprising the step of mixing a carboxylic acid amide as defined above, with one or more pesticides.

More preferably, the method comprises mixing a carboxylic acid amide where R2 and R3 are C₂-C₄ alkyl and R1 is C₂-C₇ alkyl with one or more pesticides. In an even more preferred embodiment, the method comprises mixing a carboxylic acid amide where R2 and R3 are C₂-C₄-alkyl and R1 is C₂-alkyl, in particular R2 and R3 are C₄-alkyl and R1 is C₂-alkyl with one or more pesticides. In a further preferred embodiment, the method comprises mixing a carboxylic acid amide where R2 and R3 are C₄-alkyl and R1 is C₇-alkyl with one or more pesticides. In a further preferred embodiment, the method comprises mixing a carboxylic acid amide where R2 and R3 are straight-chain C₄-alkyl and R1 is straight-chain C₇-alkyl with one or more pesticides.

Preferable, the carboxylic acid amide as defined above in an amount of from 10% by weight to 90% by weight, preferably from 30% by weight to 80% by weight is mixed with one or more pesticides.

The preparation of carboxylic acid amides as defined above is generally known in the art, for example by reacting an amine with a carboxylic acid, an ester or an acid chloride as described for example in Mitchell, J A; Reid, E E, J. Am. Chem. Soc. 1931, 1879; U.S. Pat. No. 2,472,900; DE19650107; King, J F.; Rathore, R., J. Am. Chem. Soc. 1992, 3028.

The examples which follow illustrate the invention without imposing any limitation.

### EXAMPLES

### Example 1

### Synthesis of Carboxylic Acid Amides

N,N-dibutyl-propionamide (hereinafter dibutylpropionamide) was synthesized in a two-phase system composed of 25 wt % NaOH aqueous solution (625 g), toluene (160 ml) and dibutylamine (342 g). To that ice-cooled mixture, propionic acid chloride (189 g) was added drop wise. After the addition, the reaction mixture was stirred 30 minutes at room temperature. The two phases were separated. The organic phase was fractional distillated under vaccum to obtain the purified product (335 g, 90% yield).

N,N-dibutyl-octanamide (hereinafter C₈-dibutylamide) was synthesized in a Dean-Stark apparatus using dibutylamine (194 g) and octanoic acid (147 g). The reaction mixture is heated to 160° C. for 65 h. A following vacuum distillation afforded the desired product (212 g, 83% yield).

N,N-dimethyl-propionamide (hereinafter dimethylpropionamide) was purchased from Sigma Aldrich and N,N-diethyl-propionamide (hereinafter diethylpropionamide) was purchased from TCI Europe.

### Example 2

### Phytotoxicity

For the greenhouse tests, barley (cultivar Lawina) was sown and cultivated in standard soil (type P, fine) for 3 weeks. The spray mixtures were applied with a minicompressor (4 times) in a laboratory fume hood on plants being in 3-4 leaf stage.

A spray comprising water (aqua dest.) and dibutylpropionamide from Example 1 (200 l/ha comprising 1500 ml dibutylpropionamide/ha) was prepared and applied at a water application rate of 1.5 l/ha. The experimental period lasted for 10 days. During this time, the experimental plants received optimum watering, with nutrients being supplied via the water used for watering.

The phytotoxicity was evaluated by assessing scores to the treated plants in comparison to untreated plants, i.e. treated with water only (see Table 1). The evaluation scale ranges from 0% to 100% phytotoxicity. The evaluation was done by visual examination. Thus, 0% phytotoxicity means that there were no differences between treated and untreated plants. The results in Table 1 demonstrate the phytotoxicity of the solvent, i.e. carboxylic acid amide, as a result of addition of the solvent. A rating of 0% phytotoxicity means no crop injury. A rating of 1 to 10% phytotoxicity, indicating that the plants were not significantly adversely affected and rapidly and completely recovered, is the limit of injury considered acceptable by farmers. A rating of 100% means the complete destruction of all plants. The inventive carboxylic acid amides in accordance of the present invention show a phytotoxicity of below 10% meaning that less than 10% of the plants showed necrotic damage. Thus, less than 10% of the plants were affected when said carboxylic acid amides were applied on the plants in a dose of 1500 ml/ha. However, by applying dimethylpropionamide, a non-inventive carboxylic acid amide, onto the plants, up to 43% of the plants showed necrotic damage. Thus, carboxylic acid amides wherein the N,N-alkyl groups are having more than two carbon atoms seem to have no or almost no phytotoxic effect on the plants and can therefore be used in agricultural compositions for reducing the phytotoxicity in such compositions.

TABLE 1
Phytotoxicty [%] 10 days after treatment

| Carboxylic acid amide | Phytotoxicity [%] |
|---|---|
| — ^{a)} | 0 |
| Dimethylpropionamide ^{b)} | 43 |
| Diethylpropionamide | 6 |
| Dibutylpropionamide | 0 |
| C₈-dibutylamide | 5 |

^{a)} Control experiment, not inventive, without carboxylic acid amide.
^{b)} Comparative experiment, not inventive.

### Example 3

### Determination of the Max. Solubilitiy

The respective fungicide was dissolved in the solvent of interest so that a supersaturated solution was obtained. The deposit was filtered off. The concentration of the fungicide in the supernatant was determined via quantitative 1H-NMR spectroscopy.

TABLE 2
Solubility [%] of different fungicides in carboxylic acid amides

| | Solubility [%] | Solubility [%] | Solubility [%] |
|---|---|---|---|
| Carboxylic acid amide | Tebuconazole | Pyraclostrobin | Fluxapyroxad |
| Dimethylpropionamide | 54 | 70 | 53 |
| Diethylpropionamide | 49 | 62 | 13 |
| Dibutylpropionamide | 38 | 42 | 28 |
| C₈-dibutylamide | 27 | 24 | 13 |

1. An aqueous composition comprising a pesticide and a carboxylic acid amide according to formula (A) 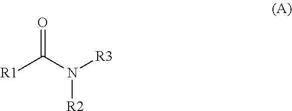
wherein
R1 is C₂-C₈ alkyl, and
R2 and R3, independently of one another, are C₁-C₆ alkyl, under the proviso that R2 is not C₁-alkyl when R3 is C₁-alkyl,
under the proviso that, if R2 and R3 are C₄-alkyl and R1 is C₂-alkyl or if R2 and R3 are C₂-alkyl and R1 is C₃-alkyl or if R2 and R3 are C₃-alkyl and R1 is C₃-alkyl, the pesticide is not chloridazon, brompyrazon or carbamate, and
under the proviso that, if R2 and R3 are C₂-alkyl and R1 is C₇-C₈-alkyl or if R2 and R3 are C₃-alkyl and R1 is C₃-C₅-alkyl or C₇-C₈-alkyl or if R2 and R3 are C₄-alkyl and R1 is C₂-C₅-alkyl or C₇-C₈-alkyl, the pesticide is not an azole-derivative according to formula (B) 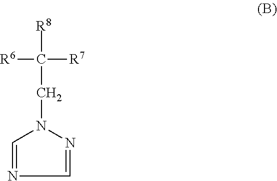
wherein
R⁶ is 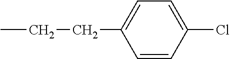
R⁷ is tert.-butyl and R⁸ is hydroxyl, or
R⁶ is 4-fluorphenyl, R⁷ is 2-fluorphenyl and R⁸ is hydroxyl, or
R⁶ is 2,4-dichlorphenyl, R⁷ is n-butyl and R⁸ is hydroxyl, or
R6 is 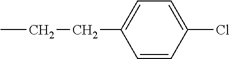
R⁷ is phenyl and R⁸ is cyano, or
R⁶ is 2-chlor-benzyl, R⁷ is 1-chlor-cycloprop-1-yl and R⁸ is hydroxyl, or
R⁶ is 4-chlorphenyl
R7 is 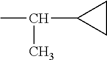
and R⁸ is hydroxyl;
and/or an azole-derivative according to formula (C) 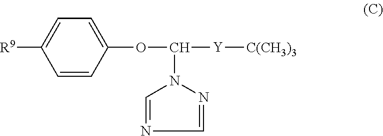
wherein
Y is —CH(OH) and R⁹ is chlor or phenyl, or
Y is CO and R⁹ is chlor
and/or an azole-derivative according to formula (D) 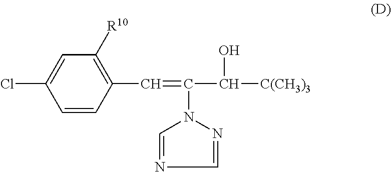
wherein R¹° is hydrogen or chlor,
and/or 1-([bis-(4-fluorphenyl)-methyl-silyl]-methyl)-1H-(1,2,4-triazol) according to formula (E) 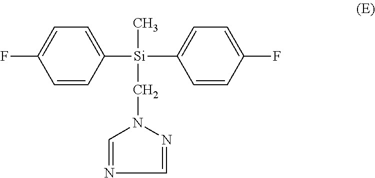 [SMILES: C[Si](Cn1cncn1)(c1ccc(F)cc1)c1ccc(F)cc1]
and/or 1-[3-(2-chlorphenyl)-2-(4-fluorphenyl)-oxiran-2-yl-methyl]-1H-(1,2,4-triazol according to formula (F)

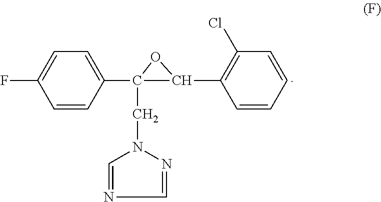 [SMILES: Fc1ccc(C2(Cn3cncn3)OC2c2ccccc2Cl)cc1]

2. The composition according to claim 1, wherein R2 and R3 are C₂-C₄ alkyl.

3. The composition according to claim 1 or 2, wherein R2 and R3 are C₂-C₄-alkyl and R1 is C₂-alkyl.

4. The composition according to claim 1, wherein R2 and R3 are C₄-alkyl and R1 is C₇-alkyl.

5. The composition according to claim 4, wherein R2 and R3 are straight-chain C₄-alkyl and R1 is straight-chain C₇-alkyl.

6. The composition according to claim 1, wherein the pesticide is selected from the group consisting of fungicides, herbicides and insecticides.

7. The composition according to claim 1, wherein the composition comprises of from 0.1% by weight to 90% by weight of the carboxylic acid amide.

8. The composition according to claim 1, wherein the composition comprises:
5 to 60% by weight of pesticide,
1 to 30% by weight of surface-active substances,
0 to 50% by weight of at least one of oil components and co-solvents, and
0.1 to 90% by weight of carboxylic acid amide,
on the condition that the amounts add with water to 100% by weight.

9. A method for at least one of controlling at least one of phytopathogenic fungi, undesirable plant growth, undesirable insect infestation, and mite infestation, and regulating the growth of plants, wherein the composition as defined in claim 1 is allowed to act on any one of the respective pests, the habit of said pests, the plants to be protected from the respective pest, the soil, undesirable plants, the crop plants and the habitat of any of said plants.

10. A process for preparing a pesticide composition, the process comprising using a solvent comprising a carboxylic acid amide according to formula (A) 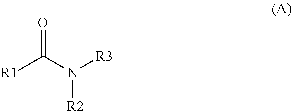
wherein
R1 is C₂-C₃ alkyl, and
R2 and R3, independently of one another, are C₁-C₆ alkyl, under the proviso that R2 is not C₁-alkyl when R3 is C₁-alkyl, with a pesticide having one of no and low phytotoxicity.

11. A method for treating plants, thereby maintaining plant health comprising the step of mixing a carboxylic acid amide as defined in claim 1 with one or more pesticides.

12. A method for producing the composition according to claim 1 comprising the step of mixing a carboxylic acid amide as defined in claim 1 with one or more pesticides.
